(19) United States
(12) Patent Application Publication
(10) Pub. No.: US 2024/0191670 A1
(43) Pub. Date: Jun. 13, 2024

(54) METHOD FOR MONITORING THE OPERATION OF AN INTERNAL COMBUSTION ENGINE, CONTROL DEVICE DESIGNED TO CARRY OUT A METHOD OF THIS TYPE, AND INTERNAL COMBUSTION ENGINE HAVING A CONTROL DEVICE OF THIS TYPE

(71) Applicant: Rolls-Royce Solutions GmbH, Friedrichshafen (DE)

(72) Inventor: Aron Toth, Friedrichshafen (DE)

(73) Assignee: Rolls-Royce Solutions GmbH, Friedrichshafen (DE)

(21) Appl. No.: 18/443,759

(22) Filed: Feb. 16, 2024

Related U.S. Application Data
(63) Continuation of application No. PCT/EP2022/072997, filed on Aug. 17, 2022.

(30) Foreign Application Priority Data
Aug. 18, 2021 (DE) 10 2021 121 478.5
Aug. 17, 2022 (WO) PCT/EP2022/072997

(51) Int. Cl. F02D 41/22

(52) U.S. Cl. CPC F02D 41/22

(57) ABSTRACT

A method for monitoring an operation of an internal combustion engine includes the steps of: detecting, during the operation of the internal combustion engine, an acoustic signal, at least partially, during a closing process of a gas exchange valve of the internal combustion engine; evaluating, based on the acoustic signal which is detected, at least one functional state of the internal combustion engine; and selecting the at least one functional state of the internal combustion engine from a group consisting of a state of the gas exchange valve and a state of a structure-borne noise sensor used to detect the acoustic signal.

### CROSS REFERENCE TO RELATED APPLICATIONS

This is a continuation of PCT application no. PCT/EP2022/072997, entitled “METHOD FOR MONITORING THE OPERATION OF AN INTERNAL COMBUSTION ENGINE, CONTROL DEVICE DESIGNED TO CARRY OUT A METHOD OF THIS TYPE, AND INTERNAL COMBUSTION ENGINE HAVING A CONTROL DEVICE OF THIS TYPE”, filed Aug. 17, 2022, which is incorporated herein by reference. PCT application no. PCT/EP2022/072997 claims priority to German patent application no. 10 2021 121 478.5, filed Aug. 18, 2021.

### BACKGROUND OF THE INVENTION

### 1. Field of the Invention

The present invention relates to internal combustion engines.

### 2. Description of the Related Art

For protection of internal combustion engines, structure-borne noise sensors are used in particular as knock sensors, to detect in particular knocking combustion and to consequently take measures to prevent the latter. If, for example, such a knock sensor fails due to a defect, a broken cable or a defective or even missing connection of the knock sensor with a control device of the internal combustion engine, the corresponding protective function is no longer provided, and the combustion engine can be damaged by knocking cycles. It is problematic that a failure of a knock sensor is not easily detected, as these sensors typically do not output a defined error voltage due to their function and design. A further difficulty is that operating cycles without knocking combustion, that is, in particular with regular combustion, produce a signal in a knock sensor which can hardly be distinguished from the signal of a defective knock sensor during knocking combustion. Thus, an opportunity is needed to monitor the functionality of knock sensors in a different manner.

At the same time, there are considerable risks for an internal combustion engine if the valve clearance of a gas exchange valve assigned to a combustion chamber is no longer available, which results in that the combustion chamber is not tightly closed at any time within an operating cycle. Therefore, there is a need for a particularly simple and cost-effective way to detect a non-existing or minimally existing valve clearance in the operation of the internal combustion engine, so that an operator of the latter can receive a timely warming.

From an economic and functional point of view, it would also be very advantageous if the same approach could be used to monitor the knock sensors of the internal combustion engine on the one hand and to monitor valve clearances on the other.

What is needed in the art is a method for monitoring the operation of an internal combustion engine, a control device equipped to carry out such a process, and an internal combustion engine having such a control device, whereby the discussed disadvantages are at least reduced, optionally avoided.

### SUMMARY OF THE INVENTION

The present invention relates to a method for monitoring the operation of an internal combustion engine, to a control device designed to carry out a method of this type, and to an internal combustion engine having a control device of this type.

The present invention provides a method for monitoring the operation of an internal combustion engine, whereby during operation of the internal combustion engine an acoustic signal is detected, at least partially, during a closing process of a gas exchange valve of the internal combustion engine. In particular, the acoustic signal is detected during the closing process of the gas exchange valve. On the basis of the detected acoustic signal, at least one functional state of the internal combustion engine is evaluated, which is selected from a group consisting of a state of the gas exchange valve and a state of a structure-borne noise sensor used to detect the acoustic signal. The inventors recognized that during the closing of a gas exchange valve, in particular on impact with a valve seat, a concise acoustic signal is produced which can be advantageously used to monitor the operation of the internal combustion engine with regard to the functionality of a structure-borne noise sensor, in particular a knock sensor, and/or with a view to valve clearance of the gas exchange valve. If there is sufficient valve clearance, the corresponding acoustic signal occurs in each operating cycle of the internal combustion engine and in each combustion chamber independently of other functional parameters, in particular independent of combustion in the combustion chamber. If the acoustic signal cannot be detected by the structure-borne noise sensor, there are only two possible reasons: either the structure-borne noise sensor is defective or has a defective connection with a control device of the internal combustion engine, or the valve clearance for the gas exchange valve is no longer available, so that it no longer closes completely. In either case, an appropriate response is required, as continued operation of the internal combustion engine is associated with risks. This means that the functionality of the structure-borne noise sensor and/or the valve clearance can be reliably monitored easily and cost-effectively, especially in a common approach.

In particular, a structure-borne noise signal is captured as an acoustic signal. This structure-borne noise signal propagates in particular through the valve body, so that the structure-borne noise sensor can detect this signal through the valve body and it is not necessary to introduce the structure-borne noise sensor into the interior of the gas exchange valve. It is possible to detect the acoustic signal, in particular the structure-borne noise signal, on another part of the internal combustion engine, in particular on a crankcase and/or cylinder head. Optionally, the acoustic signal, especially the structure-borne noise signal, is recorded in the form of an electrical voltage, in particular alternating voltage. More particularly, the output voltage of the structure-borne noise sensor is herein captured as alternating voltage. The characteristic of a structure-borne noise sensor of emitting an alternating voltage is in particular a reason as to why the structure-borne noise sensor cannot easily output a predetermined error voltage when a defect occurs.

In the context of the current technical teaching, a gas exchange valve is understood in particular to be a valve assigned to a combustion chamber of the internal combustion engine, which is designed to admit a gas or gas mixture into the combustion chamber or to discharge it from the combustion chamber. In particular, the gas exchange valve is an inlet valve or a discharge valve. In an optional embodiment of the present invention, the gas exchange valve is an inlet valve.

According to a further development of the present invention, it is provided that the acoustic signal is at least partially detected during the closing process of an inlet valve of the internal combustion engine. In particular, the acoustic signal is detected during the closing process of the inlet valve. The gas exchange valve is therefore in particular an inlet valve. The closing process of the inlet valve is thereby particularly suitable for monitoring the operation of the internal combustion engine as herein described.

A further development of the present invention provides that the acoustic signal is detected in a—first—detection range of 2400 crankshaft angle (° KW) to 1350 KW before a top dead center of a piston of the internal combustion engine assigned to an ignition timing. Especially in this detection range, the closing of the inlet valve can be reliably detected if the structure-borne noise sensor is functioning and there is sufficient valve clearance. The top dead center of the piston assigned to the ignition timing is also referred to as ignition TDC, in particular in contrast to a top dead center of the piston assigned to a gas exhaust stroke.

In an optional embodiment, the acoustic signal is detected in a detection range of 225° crankshaft angle KW to 1350 crankshaft angle KW, optionally from 2100 crankshaft angle KW to 150° crankshaft angle KW upstream of the ignition TDC. Especially in this detection range, the closing of the inlet valve can be reliably detected if the structure-borne noise sensor is functioning correctly and if there is sufficient valve clearance, while at the same time the detection range is advantageously limited in order to reduce the data volume.

In an optional embodiment of the present invention, the acoustic signal of the structure-borne noise sensor is additionally detected in a—second—detection range in which knocking combustion is expected, in particular in a range of 0° crankshaft angle KW to 50° crankshaft angle KW after the ignition TDC. In this way, the structure-borne noise sensor is used advantageously to detect knocking combustion. The structure-borne noise sensor is therefore used in particular as a knock sensor.

According to a further development of the present invention, it is provided that the detected acoustic signal is filtered by way of a low-pass filter, from which a filtered acoustic signal is obtained. Thus, a low-noise or noise-reduced signal is advantageously obtained, which—with a reduced amount of data—contains the essential information in regard to the closing process of the gas exchange valve.

According to a further development of the present invention, it is provided that a magnitude variable of the detected acoustic signal is formed, from which a magnitude signal is obtained. On the one hand, this approach further reduces the amount of data to be processed while at the same time retaining the essential information of the acoustic signal in regard to the closing process; and on the other hand, the formation of the magnitude variable advantageously enables subsequent integration of the acoustic signal without loss of information.

In the context of the present technical teaching, a magnitude variable of the detected acoustic signal is understood to be, in particular, a variable that correlates with the absolute variable of the acoustic signal when omitting a sign of the acoustic signal. In particular, an even power, in particular a square, a root function of the even power, in particular the square root of the squared acoustic signal, or a magnitude function of the acoustic signal, in particular a magnitude of the acoustic signal, can be used as the magnitude variable.

In one embodiment, the magnitude variable is formed by the filtered acoustic signal, from which the magnitude signal is obtained.

A further development of the present invention provides that the detected acoustic signal is integrated over an integration range within the detection range, from which an integral value is obtained. This advantageously enables further reduction of the amount of data, wherein simultaneously with the integral value a value is obtained which reliably reflects the essential information about the closing procedure, namely whether the closing procedure can be detected.

In the context of the current technical teaching, the fact that the integration range is within the detection range, means in particular that integration range is at least part of the detection range. In an optional design, it is provided that the detected acoustic signal is integrated over the entire detection range, in other words, that the integration range corresponds to the detection range or is identical with same.

In an optional embodiment, the filtered acoustic signal is integrated over the integration range, from which the integral value is obtained.

In another optional embodiment, the magnitude signal is integrated over the integration range, from which the integral value is obtained. In particular, the magnitude signal obtained from the filtered acoustic signal is optionally integrated over the integration range, from which the integral value is obtained.

According to a further development of the present invention, it is provided that the integral value is compared with a predetermined threshold value. The at least one functional state of the internal combustion engine is considered not to be in order if the integral value drops below the predetermined threshold value. At least one functional state of the internal combustion engine is considered to be in order if the integral value reaches or exceeds the predetermined threshold value. By comparing the integral value with the predetermined threshold value, it can be decided in particular, whether the acoustic signal could be detected or not. The predetermined threshold value is thus advantageously selected in particular so that the acoustic signal was reliably detected if the integral value reaches or exceeds the predetermined threshold value, while it can be assumed that the acoustic signal was not detected if the integral value drops below the predetermined threshold value. If the acoustic signal was not detected, the knock sensor is either defective or inadequately or not at all connected to the control device, or alternatively the valve clearance of the gas exchange valve is no longer available, so that it no longer closes completely.

The predetermined threshold value is advantageously determined one time for a certain type of combustion engine or alternatively also for the individual combustion engine and is optionally stored in the control device of the combustion engine.

If the functional state of the internal combustion engine is found not to be in order, an alarm signal is issued in an optional configuration and/or the combustion engine is switched off—in particular automatically. In the context of the current technical teaching, an alarm signal is understood in particular as a visual, acoustic and/or another warning that is recognizable by the operator of the internal combustion engine.

According to a further development of the present invention, it is provided that a plurality of acoustic signals for the same combustion chamber of the internal combustion engine—in particular in a plurality of operating cycles—will be detected consecutively. From the consecutively detected acoustic signals, a temporal progression of the acoustic signal is obtained. At least one functional state of the internal combustion engine is evaluated on the basis of the temporal progression of the acoustic signal. In this way, the internal combustion engine can be continuously monitored on the one hand, and on the other hand, a chronological development of the function of the combustion engine can be observed.

In the context of the current technical theory, a temporal progression of the plurality of acoustic signals or—in short—of the acoustic signal is understood to mean the chronological development of the detected acoustic signal over the plurality of successive detections, in particular in contrast to a temporal progression within the detection range. In particular, the temporal progression allows an assessment of how the acoustic signal develops from one detection event to the next detection event or over a plurality of detection events.

In one optional embodiment, at least one functional state of the internal combustion engine is evaluated on the basis of the temporal progression of the integral value. In particular, the associated integral value is formed for each detected acoustic signal, and its temporal progression is used to evaluate at least one functional state. In particular, assessments are made as to whether the integral value drops below the predetermined threshold value at any one time.

In one embodiment, at least one functional state is found to be out of order if the integral value drops below the predetermined threshold value for a predetermined time limit period. Through appropriate definition of the predetermined time limit period it can be advantageously prevented that a random, short-term outlier leads to an erroneous evaluation of the functional state. In contrast, at least one functional state is found to be in order, in particular if the integral value drops below the predetermined threshold value for a shorter period of time than the predetermined time limit period.

According to a further development of the present invention, it is provided that the operation of an internal combustion engine with a plurality of combustion chambers will be monitored. An acoustic signal is detected separately for each combustion chamber. The at least one functional state of the internal combustion engine is evaluated on an individual combustion chamber basis. In particular, a separate structure-borne noise sensor is assigned to each combustion chamber, which detects the corresponding acoustic signal for the assigned combustion chamber. At the same time, this is advantageous for monitoring for knocking combustion, which can also be carried out individually for a combustion chamber. With the help of the method proposed here, the functionality of each knock sensor can now be carried out individually for each combustion chamber. Alternatively, or additionally, at least one gas exchange valve for each combustion chamber can be monitored for clearance that is no longer available.

The present invention also provides a control device for an internal combustion engine which is equipped to carry out a method of the present invention or a method according to one or more of the embodiments described above. In connection with the control device, in particular, the advantages that have already been explained in connection with the method are realized.

The control device has optionally at least one interface for connection to at least one structure-borne noise sensor, especially a knock sensor.

Ultimately, the present invention also provides an internal combustion engine that has at least one combustion chamber to which a gas exchange valve is assigned. The internal combustion engine also has at least one structure-borne noise sensor assigned to the combustion chamber. The internal combustion engine also has a control device according to the present invention or a control device according to one or more of the embodiments described above. The control device is operatively connected to at least one structure-borne noise sensor. In connection with the internal combustion engine, there are advantages in particular, that have already been explained in connection with the method and the control device.

In one optional embodiment, the internal combustion engine has a plurality of combustion chambers, with each combustion chamber being assigned at least one gas exchange valve and one structure-borne noise sensor. The control device is operatively connected to the structure-borne noise sensors and is designed to monitor at least one functional status of the combustion engine individually in respect to the combustion chamber.

In one optional design, the internal combustion engine is designed as a reciprocating piston engine. In a different optional design, the internal combustion engine is designed as a rotary piston engine.

In the optional design, the internal combustion engine is designed as a gas engine, in particular as a stationary gas engine.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of an embodiment example of an internal combustion engine with an embodiment example of a control device;

FIG. 2 is a schematic representation of a first embodiment of a method for monitoring the operation of an internal combustion engine; and

FIG. 3 is a schematic representation of a second embodiment of a method for monitoring the operation of an internal combustion engine.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

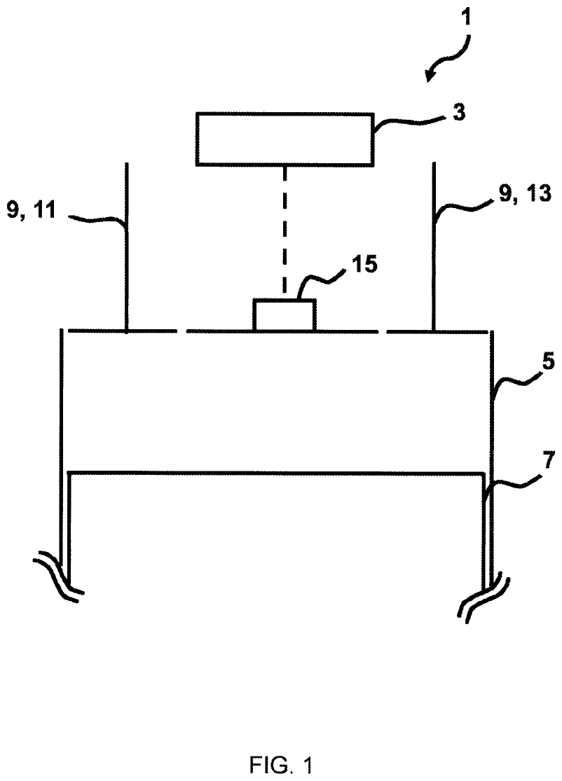

FIG. 1 shows a schematic representation of an embodiment example of an internal combustion engine 1 with an embodiment example of a control device 3.

Internal combustion engine 1 includes at least one combustion chamber 5, in which, in an optional embodiment, a piston 7 is arranged to move in a reciprocating manner. However, internal combustion engine 1 can also be designed as a rotary piston engine or in another suitable manner.

At least one gas changeover valve 9 is assigned to combustion chamber 5, whereby in particular an inlet valve 11 and a discharge valve 13 are shown as gas exchange valves 9.

Combustion chamber 5 also has assigned to it a structure-borne noise sensor 15 which is operatively connected to control device 3.

In an optional design, combustion engine 1 has a number of—in particular identical—combustion chambers 5, whereby in particular each combustion chamber 5 is assigned at least one gas exchange valve 9 and one structure-borne noise sensor 15 each. Structure-borne noise sensors 15 are each operatively connected to control device 3.

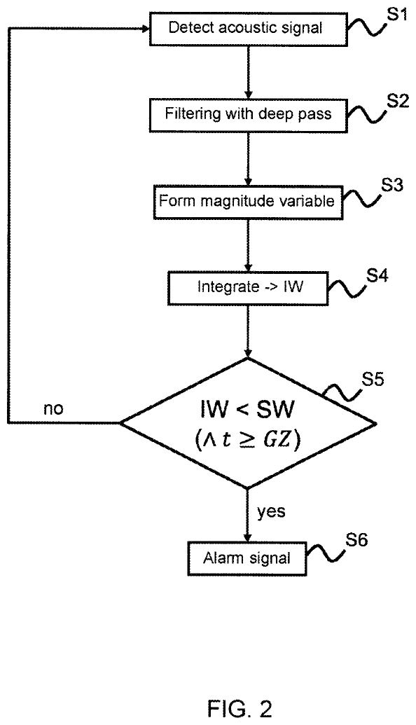

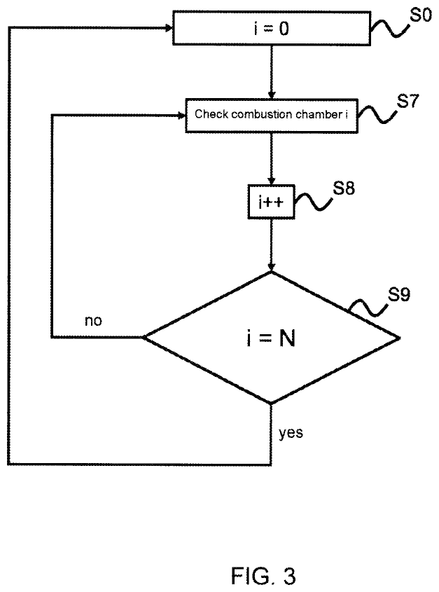

Control device 3 is specifically designed to carry out a method for monitoring the operation of internal combustion engine 1, which is described in more detail below in connection with FIGS. 2 and 3.

FIG. 2 shows a schematic representation of a first embodiment of a method for monitoring the operation of an internal combustion engine 1, in particular of internal combustion engine 1 as shown in FIG. 1.

In a first step S1, during operation of internal combustion engine 1, an acoustic signal is detected at least partially by way of structure-borne noise sensor 15 during a closing process of gas exchange valve 9, in particular inlet valve 11. Then, on the basis of the detected acoustic signal, at least one functional state of internal combustion engine 1 is evaluated, whereby at least one functional state of internal combustion engine 1 is selected from a group consisting of a state of gas exchange valve 9 and a state of structure-borne noise sensor 15.

In first step S1, the acoustic signal is optionally detected in a detection range from 240° KW to 135° KW, optionally from 225° KW to 135° KW, optionally from 210° KW to 150° KW, before a top dead center of piston 7 of internal combustion engine 1 assigned to an ignition timing.

In a second step, S2, the acoustic signal is optionally filtered by way of a low-pass filter, from which a filtered acoustic signal is obtained.

Optionally, in a third step S3, a magnitude variable of the detected acoustic signal, in particular the filtered acoustic signal, is formed, from which a magnitude signal is obtained.

Optionally, in a fourth step S4, the detected acoustic signal, in particular the filtered acoustic signal, optionally the magnitude signal obtained in third step S3, is integrated over an integration range within the detection range, from which an integral value IW is obtained.

Integral value IW is optionally compared with a predetermined threshold value SW in a fifth step S5, whereby a check is conducted, in particular whether integral value IW drops below predetermined threshold value SW.

If, in fifth step S5, it is determined that integral value IW does not drop below predetermined threshold value SW, the at least one functional state of internal combustion engine 1 is found to be in order, and the process is optionally continued in first step S1. In particular, the process is optionally carried out continuously during the operation of internal combustion engine 1. In particular, a plurality of acoustic signals for same combustion chamber 5 of internal combustion engine 1 is thereby detected consecutively, wherein the at least one functional state of combustion engine 1 can be evaluated on the basis of the temporal progression, in particular of integral value IW.

If, in contrast, it is determined in fifth step S5 that integral value IW drops below predetermined threshold value SW, an alarm signal is optionally issued in a sixth step S6 or combustion engine 1 is switched off. In this case, it is recognized in particular, that either structure-borne noise sensor 15 is defective or not correctly connected to control device 3, or that a valve clearance of gas changeover valve 9, in particular inlet valve 11, is no longer available so that it no longer closes completely.

However, in an optional arrangement, sixth step S6 is not yet initiated when it is determined for the first time that integral value IW drops below predetermined threshold value SW; rather, the procedure is optionally continued with first step S1, and it is also checked in fifth step S5 whether integral value IW already drops below predetermined threshold value SW for at least a predetermined critical time limit period GZ. Only, if this condition is also met, sixth step S6 is carried out. In this way, in particular, a plurality of acoustic signals for same combustion chamber 5 of internal combustion engine 1 is detected consecutively, wherein the at least one functional state of combustion engine 1 is evaluated on the basis of the temporal progression of the detected acoustic signals, in particular of integral values IW.

The method can be carried out in parallel or sequentially for a plurality of combustion chambers 5 of combustion engine 1, wherein an acoustic signal is optionally detected separately for each combustion chamber 5, and wherein at least one functional state of combustion engine 1 is evaluated individually for a combustion chamber.

FIG. 3 is a schematic representation of a second embodiment of a method for monitoring the operation of an internal combustion engine 1. In particular, sequential monitoring of a plurality of combustion chambers 5, namely a predetermined number of N combustion chambers 5, of the internal combustion engine 1, is carried out.

In an initial step S0, a control variable i is initialized, optionally with the initial value being zero.

In a seventh step, S7, the method described above, in particular steps S1 to S6 described in connection with FIG. 2, is first carried out for a combustion chamber 5 of internal combustion engine 1 assigned to the current value of control variable i. Subsequently, control variable i is incremented in an eighth step S8.

Under the implicit prerequisite that the operation of internal combustion engine 1 has not yet been switched off, it is verified in a ninth step S9 whether the value of control variable i corresponds to the number N of combustion chambers 5. If this is not yet the case, the procedure is continued in the seventh step S7. If, on the other hand, the value running variable i corresponds to the number of N combustion chambers 5, the procedure is either terminated or—as shown here—continued in an optional arrangement with initial step S0, so that the procedure is carried out—in particular continuously—during the operation of internal combustion engine 1.

Thus, all combustion chambers 5 of combustion engine 1 are checked sequentially.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for monitoring an operation of an internal combustion engine, the method comprising the steps of:
detecting, during the operation of the internal combustion engine, an acoustic signal, at least partially, during a closing process of a gas exchange valve of the internal combustion engine;
evaluating, based on the acoustic signal which is detected, at least one functional state of the internal combustion engine; and
selecting the at least one functional state of the internal combustion engine from a group consisting of a state of the gas exchange valve and a state of a structure-borne noise sensor used to detect the acoustic signal.

2. The method according to claim 1, wherein the acoustic signal is at least partially detected during a closing process of an inlet valve of the internal combustion engine.

3. The method according to claim 1, wherein the acoustic signal is detected in a detection range from 2400 KW to 1350 KW, before a top dead center of a piston of the internal combustion engine assigned to an ignition timing.

4. The method according to claim 3, wherein the acoustic signal is detected in a detection range from 225° KW to 135° KW.

5. The method according to claim 3, wherein the acoustic signal is detected in a detection range from 210° KW to 1500 KW.

6. The method according to claim 3, wherein the acoustic signal which is detected is filtered by way of a low-pass filter, from which a filtered acoustic signal is obtained.

7. The method according to claim 3, wherein a magnitude variable of the acoustic signal which is detected is formed, from which a magnitude signal is obtained.

8. The method according to claim 3, wherein the acoustic signal which is detected is filtered by way of a low-pass filter, from which a filtered acoustic signal is obtained, and wherein a magnitude variable of the filtered acoustic signal is formed, from which a magnitude signal is obtained.

9. The method according to claim 3, wherein the acoustic signal which is detected is integrated over an integration range within the detection range, from which an integral value is obtained.

10. The method according to claim 3, wherein the acoustic signal which is detected is filtered by way of a low-pass filter, from which a filtered acoustic signal is obtained, and wherein the filtered acoustic signal is integrated over an integration range within the detection range, from which an integral value is obtained.

11. The method according to claim 3, wherein a magnitude variable of the acoustic signal which is detected is formed, from which a magnitude signal is obtained, and wherein the magnitude signal is integrated over an integration range within the detection range, from which an integral value is obtained.

12. The method according to claim 3, wherein the acoustic signal which is detected is integrated over an integration range within the detection range, from which an integral value is obtained, wherein the integral value is compared with a predetermined threshold value, wherein the at least one functional state of the internal combustion engine is considered not to be in order if the integral value drops below the predetermined threshold value, and wherein the at least one functional state of the internal combustion engine is considered to be in order if the integral value reaches or exceeds the predetermined threshold value.

13. The method according to claim 3, wherein the acoustic signal which is detected is integrated over an integration range within the detection range, from which an integral value is obtained, wherein a plurality of the acoustic signal for a respective combustion chamber of the internal combustion engine are detected consecutively, wherein the least one functional state of the internal combustion engine is evaluated based on a temporal progression of the plurality of the acoustic signal which are detected, and wherein the at least one functional state is considered not to be in order if the integral value drops below a predetermined threshold value for a predetermined time limit period.

14. The method according to claim 3, wherein the acoustic signal which is detected is integrated over an integration range within the detection range, from which an integral value is obtained, wherein a plurality of the acoustic signal for a respective combustion chamber of the internal combustion engine are detected consecutively, wherein the least one functional state of the internal combustion engine is evaluated based on a temporal progression of the integral value, and wherein the at least one functional state is considered not to be in order if the integral value drops below a predetermined threshold value for a predetermined time limit period.

15. The method according to claim 1, wherein the operation of the internal combustion engine with a plurality of combustion chambers is monitored, wherein an acoustic signal is detected separately for each individual one of the plurality of combustion chambers, and wherein the at least one functional state of the internal combustion engine is evaluated with respect to each individual one of the plurality of combustion chambers.

16. A control device for an internal combustion engine, the control device comprising:
the control device, which is configured for carrying out a method for monitoring an operation of an internal combustion engine, the method including the steps of:
detecting, during the operation of the internal combustion engine, an acoustic signal, at least partially, during a closing process of a gas exchange valve of the internal combustion engine;
evaluating, based on the acoustic signal which is detected, at least one functional state of the internal combustion engine; and
selecting the at least one functional state of the internal combustion engine from a group consisting of a state of the gas exchange valve and a state of a structure-borne noise sensor used to detect the acoustic signal.

17. An internal combustion engine, comprising:
a gas exchange valve;
at least one combustion chamber, to which the gas exchange valve is assigned;
at least one structure-borne noise sensor assigned to the at least one combustion chamber;
a control device, which is configured for carrying out a method for monitoring an operation of the internal combustion engine, the method including the steps of:
detecting, during the operation of the internal combustion engine, an acoustic signal, at least partially, during a closing process of the gas exchange valve of the internal combustion engine;
evaluating, based on the acoustic signal which is detected, at least one functional state of the internal combustion engine; and
selecting the at least one functional state of the internal combustion engine from a group consisting of a state of the gas exchange valve and a state of the at least one structure-borne noise sensor used to detect the acoustic signal,
the control device being operatively connected with the at least one structure-borne noise sensor.
